(19) United States
(12) Patent Application Publication
(10) Pub. No.: US 2011/0161069 A1
(43) Pub. Date: Jun. 30, 2011

(54) METHOD, COMPUTER PROGRAM PRODUCT AND APPARATUS FOR PROVIDING A THREAT DETECTION SYSTEM

(75) Inventor: Christopher David Staffel, Round Rock, TX (US)

(73) Assignee: Aptus Technologies, Inc.

(21) Appl. No.: 12/649,624

(22) Filed: Dec. 30, 2009

(51) Int. Cl. G06F 17/27

(52) U.S. Cl. 704/9

(57) ABSTRACT

An apparatus for providing a threat detection system may include a processor configured to at least to perform parsing data to identify terms included in a lexicon of multi-dimensional threat factors, generating scoring results for at least some of the terms, and providing a graphical display of at least some of the terms based on the scoring results. A corresponding method and computer program product are also provided.

### TECHNOLOGICAL FIELD

Embodiments of the present invention relate generally to search and analysis technologies and, more particularly, relate to a method, computer program product and apparatus for providing a threat detection system such as, for example, a violent anti-social act threat detection system.

### BACKGROUND

Numerous federal, state and local agencies operating in the areas of defense, law-enforcement and intelligence are placing increasingly larger emphasis on the collection of human intelligence (HUMINT). In addition, such agencies also gather information from other sources in order to analyze a wide range of information to find, determine or predict emerging threats. In order to conduct analysis of the gathered information, the agencies often employ intelligence analysts who must devote considerable amounts of time to activities such as reading reports, monitoring chat rooms, and browsing the web in order to enable processing of the information gathered from other sources. This means that the time available for analyzing information in an in depth fashion is significantly reduced. Moreover, some information that may indicate or describe a threat or terrorist attack may be deeply buried within the volumes of information that analysts must sift through and such information may be easily missed, overlooked, or simply not recognized. In short, operational and strategic analysts, as well as intelligence collectors or tactical analysts may be overwhelmed.

Accordingly, it may be beneficial to develop a tool to assist analysts and tactical operators in handling volumes of information in a manner that facilitates the identification of real threats.

### BRIEF SUMMARY

A method, apparatus and computer program product are therefore provided for enabling the provision of a threat detection system. In this regard, for example, some embodiments of the present invention may enable the employment of presence a computer based analysis tool that provides a robust platform for identifying, within potentially large volumes of data, information that is related to multi-dimensional threat factors. Furthermore, some embodiments may provide for a flexible user interface configured to make identification of multi-dimensional threat factors relatively easy and to improve a user's ability to digest and analyze information provided. Accordingly, in some instances analysts may be enabled to instantaneously identify threats in real time or near real time while employing the system to analyze stored or live feed data.

In one example embodiment, a method of providing a threat detection system is provided. The method may include parsing data to identify terms included in a lexicon of multi-dimensional threat factors, generating scoring results for at least some of the terms, and providing a graphical display of at least some of the terms based on the scoring results.

In another example embodiment, a computer program product for providing a threat detection system is provided. The computer program product includes at least one computer-readable storage medium having computer-executable program code instructions stored therein. The computer-executable program code instructions may include program code instructions for parsing data to identify terms included in a lexicon of multi-dimensional threat factors, generating scoring results for at least some of the terms, and providing a graphical display of at least some of the terms based on the scoring results.

In another example embodiment, an apparatus for providing a threat detection system is provided. The apparatus may include a processor configured to at least to perform parsing data to identify terms included in a lexicon of multi-dimensional threat factors, generating scoring results for at least some of the terms, and providing a graphical display of at least some of the terms based on the scoring results.

Embodiments of the invention may provide a method, apparatus and computer program product for employment in any number of networks where content (e.g., HUMINT) may be shared or accessed in a secure or non-secure environment. As a result, for example, analysts and operators may work together to improve threat detection capabilities.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a communication system according to an example embodiment of the present invention;

FIG. 2 is a schematic block diagram of an apparatus for providing a threat detection system according to an example embodiment of the present invention;

FIG. 3 illustrates an example of a user interface screen according to an example embodiment of the present invention;

FIG. 4 illustrates an example of a summary page for detailed information regarding a selected term according to an example embodiment of the present invention;

FIG. 5 illustrates an example of a report that may provide information for parsing according to an example embodiment of the present invention; and

FIG. 6 is a block diagram according to an example method for providing a threat detection system according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As defined herein a “computer-readable storage medium,” which refers to a physical storage medium (e.g., volatile or non-volatile memory device), can be differentiated from a “computer-readable transmission medium,” which refers to an electromagnetic signal.

Some embodiments of the present invention provide a system that may be employed to improve the effectiveness of monitoring for threats related to terror attacks or other politically, religiously or ideologically motivated violent actions that may be planned by parties seeking to benefit from such activities. Moreover, some embodiments of the present invention may provide a mechanism by which locally or even remotely located operatives may provide vast volumes of information that can be parsed for applicable information (e.g., multi-dimensional threat factors) that may be indicative of tangible threats that exist. The parsing of the information may be performed by an electronic device or circuitry configured to enable such parsing and the results may be initially analyzed by a computer, an algorithm or other automated means and the results may be provided for analysis by a human user. In some embodiments, a specialized interface by which the user receives information related to the computer analyzed data may also be provided. It should be noted that while terrorist and other anti-social violent threats are specifically described as an example environment in which example embodiments may be practiced, some embodiments may also be used to identify other threat related factors in other fields as well (e.g., health and safety threats).

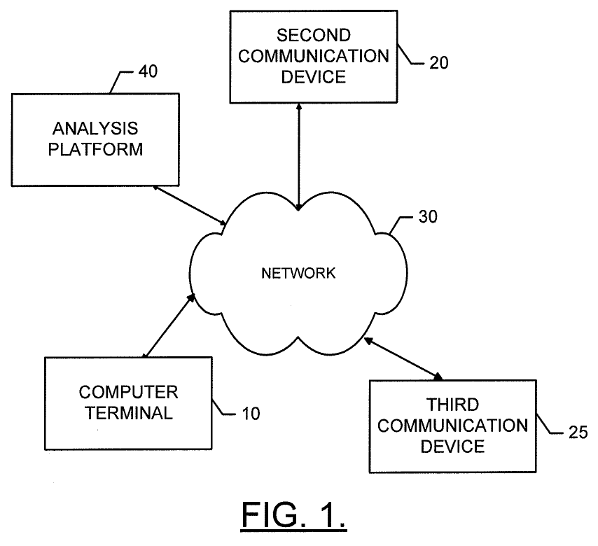

FIG. 1 illustrates a generic system diagram in which a device such as a computer terminal 10, which may benefit from embodiments of the present invention, is shown in an exemplary communication environment. As shown in FIG. 1, an embodiment of a system in accordance with an example embodiment of the present invention may include a first communication device (e.g., computer terminal 10) and a second communication device 20 (e.g., a mobile terminal) capable of communication with a network 30. In some cases, embodiments of the present invention may further include one or more additional devices (e.g., third communication device 25). In an exemplary embodiment, the system may also include still other devices such as an analysis platform 40 which may also be capable of communication with the network 30.

In an exemplary embodiment, any or all of the computer terminal 10, the second and third communication devices 20 and 25, and the analysis platform 40 may be capable of communication with each other via the network. However, in other situations, any or all of the computer terminal 10, the second and third communication devices 20 and 25, and the analysis platform 40 may be capable of making discrete connections with the network 30 and/or each other in order to send data to or receive data from the network or devices connected to the network 30.

In some embodiments, the computer terminal 10, the second and third communication devices 20 and 25, and/or the analysis platform 40 may be a fixed or mobile computing device (e.g., a PC, laptop or other computer). Furthermore, in some cases, the second and third communication devices 20 and 25 may be any of multiple types of mobile communication and/or computing devices such as, for example, portable digital assistants (PDAs), mobile telephones, email devices, and other types of text (and perhaps even voice or video) communications devices.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. However, in other cases, the network 30 may include communication interfaces supporting landline based or wired communication.

One or more communication terminals such as the computer terminal 10 and the second and third communication devices 20 and 25 may be capable of communication with each other via the network 30 and therefore include an antenna or antennas for transmitting signals to and for receiving signals wirelessly as a part of one or more cellular or mobile networks or an access point that may be coupled to a data network, such as a local area network (LAN), a metropolitan area network (MAN), and/or a wide area network (WAN), such as the Internet. By directly or indirectly connecting the aforementioned devices and other devices to the network 30, such devices may be enabled to communicate with each other, for example, according to numerous communication protocols including Hypertext Transfer Protocol (HTTP) and/or the like, to thereby carry out various communication or other functions of the computer terminal 10, the second and third communication devices 20 and 25, and the analysis platform 40, respectively.

Regardless of the form of instantiation of the devices involved, embodiments of the present invention may enable devices (e.g., the second and third communication devices 20 and 25) to remotely or locally generate content (e.g., intelligence reports) for upload to the analysis platform 40. The analysis platform 40 may then process the content according to embodiments of the present invention and provide digestible information to a user. In some cases, the information may be presented to a user that remotely or locally accesses the information via the network 30 (e.g., via the computer terminal 10). However, in some cases, the computer terminal 10 and the analysis platform 40 may be included as parts of or embodied as the same device.

In an example embodiment, the analysis platform 40 may be a device or node such as a server or other processing circuitry. The analysis platform 40 may have any number of functions or associations with various services. As such, for example, the analysis platform 40 may be a platform such as a dedicated server, backend server, or server bank associated with a particular function or service. However, as indicated above, the analysis platform 40 could alternatively be embodied at a single computer or even a laptop. In any case, the analysis platform 40 may be capable of providing one or more of a plurality of different services or functions. The functionality of the analysis platform 40 may be provided by hardware and/or software components configured to operate in accordance with known techniques for the provision of information to users of communication devices, except as modified as described herein.

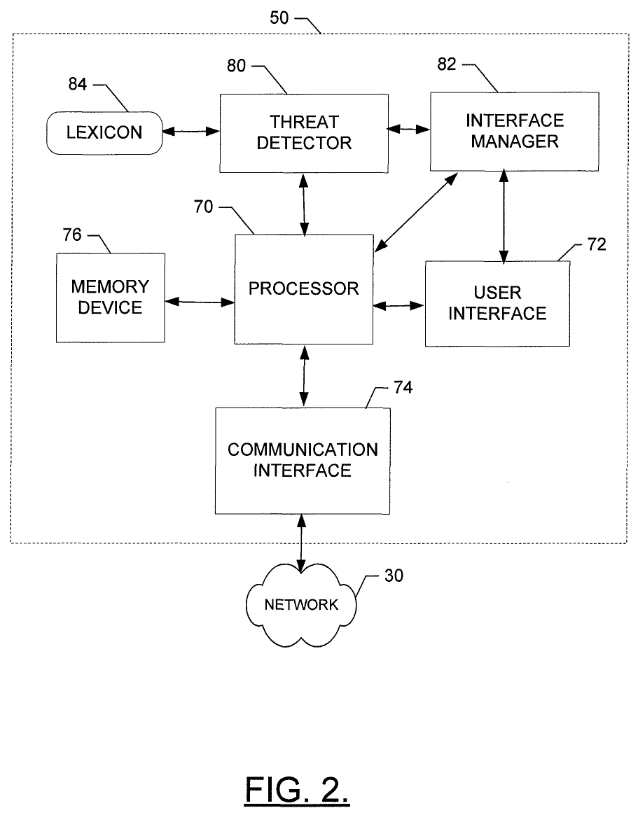

FIG. 2 illustrates a schematic block diagram of an apparatus for enabling the provision of a threat detection system according to an example embodiment of the present invention. An exemplary embodiment of the invention will now be described with reference to FIG. 2, in which certain elements of an apparatus 50 for providing a threat detection system are displayed. The apparatus 50 of FIG. 2 may be employed, for example, on a communication device (e.g., the computer terminal 10 and/or the analysis platform 40) or a variety of other devices, both mobile and fixed (such as, for example, any of the devices listed above). Alternatively, embodiments may be employed on a combination of devices. Accordingly, some embodiments of the present invention may be embodied wholly at a single device or by devices in a client/server relationship. Furthermore, it should be noted that the devices or elements described below may not be mandatory and thus some may be omitted in certain embodiments.

Referring now to FIG. 2, an apparatus 50 for providing a threat detection system is provided. The apparatus 50 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (e.g., a computer readable storage medium) comprising gates or other structure configured to store data (e.g., bits) that may be retrievable by a machine (e.g., a computing device). The memory device 76 may be configured to store information, data, applications, instructions or the like for enabling the apparatus to carry out various functions in accordance with example embodiments of the present invention. For example, the memory device 76 could be configured to buffer input data for processing by the processor 70. Additionally or alternatively, the memory device 76 could be configured to store instructions for execution by the processor 70. In some embodiments, the memory device 76 may also or alternatively store content items (e.g., media content, documents, chat content, message data, videos, music, pictures and/or the like) comprising group content.

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, processing circuitry, or the like. In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing embodiments of the present invention by further configuration of the processor 70 by instructions for performing the algorithms and/or operations described herein. In some cases, the processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an example embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like.

In an example embodiment, the processor 70 may be embodied as, include or otherwise control a threat detector 80 and an interface manager 82. The threat detector 80 and the interface manager 82 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the threat detector 80 and the interface manager 82, respectively, as described below. Thus, in examples in which software is employed, a device or circuitry (e.g., the processor 70 in one example) executing the software forms the structure associated with such means.

In an example embodiment, the threat detector 80 may be configured to parse data for specific terms listed in a lexicon 84. The data to be parsed may be stored in the memory device 76 (e.g., as complete documents or as a conglomeration of stored portions of documents such as intelligence reports) or the data may be accessed via existing databases, or open source reporting (e.g., blogs, websites, SMS messages, emails on the World Wide Web, etc.). The lexicon 84 may include words, phrases or other combinations of characters that have been added either by the user or by system designers. The lexicon 84 may be stored in the memory device 76 or otherwise be accessible to the threat detector 80. In an example embodiment, the lexicon 84 may include terms that are associated with threats based on any of multiple dimensions that define a typical credible threat. In this regard, terror attacks are often planned in order to provide a very specific desired outcome. As such, a terror attack typically has a defined target, a specific method and actor designated to strike the corresponding target in the corresponding method. A terror attack may also be associated with a specific inspiration for conducting the attack. Thus, the target, inspiration, method and actor may each be considered to be separate dimensions associated with any generic threat.

During the planning stages of a premeditated crime such as a terror attack, the dimensions of the plan may become more concrete as the plan is further advanced. For example, a terror organization may initially be inspired to conduct an attack on a certain target. During initial planning stages, intelligence regarding the planned attack may only be able to determine an inspiration and a target. However, as the plan for attack develops and solidifies, a method of attack may be decided and eventually actors to conduct the attack may be assigned. Thus, in initial stages of identifying a threat, a smaller number of dimensional threat factors may be in play. However, more dimensions may become identifiable as the threat becomes more credible and more concrete. Thus, a recent confluence of threat factors from multiple dimensions may be more indicative of an imminent threat than even a large concentration of data points regarding just one or two threat factors. The threat detector 80 may be configured to identify the presence of multiple dimensions of threat factors and classify threat levels based on weights assigned to the specific factors discovered.

The lexicon 84 may provide a listing of different targets, inspirations, methods, and actors that are known to exist and that can be searched for and extracted from massive amounts of data. As indicated above, the lexicon 84 may have some initial population of terms based on known threats at the time the system is designed or installed. However, the user may be enabled to add additional terms to the lexicon 84 as such terms become known. Furthermore, in some embodiments, the lexicon 84 may be grown automatically as the threat detector 80 may, in some cases, learn new threat terminology via the parsing activities in which the threat detector 80 is engaged. The automatic or machine learning that may be accomplished by the threat detector may be immediate in some cases. However, in other cases, user input may also be solicited. As an example, based on existing threat factor terminology, the threat detector 80 may recognize patterns, synonyms, similar terminology or other phenomena that may suggest a particular term should be added to the lexicon 84. In some cases, the threat detector 80 may offer suggestions for a user to confirm or deny. However, in other cases, the threat detector 80 may study candidate terms until a predefined confidence level is reached that such terms should be added to the lexicon 84. In response to the confidence level being reached for any particular candidate term, the candidate term may be added to the lexicon 84.

The threat detector 80 may be configured to search data provided via the network 30 or accessible via the network 30 for terms located in the lexicon 84. When a term from the lexicon 84 is found, the corresponding term may be assigned a weighting value. In some embodiments, the weighting value may be increased based on the proximity of one term to one or more additional terms in the lexicon 84. As such, for example, when two terms from the lexicon 84 are located relatively close to one another in a document, each term may receive an increased weight. The closer the terms are to each other, the more the weight may be increased. The threat detector 80 may be configured to extract each of the multi-dimensional threat factors with the corresponding weights assigned thereto, in order to identify each respective threat factor for possible presentation via the interface manager 82.

Although proximity of a term in the lexicon 84 to another term in the lexicon 84 may impact term weighting, other factors may also impact weighting of terms. For example, proximity to terms of different dimensions may increase weights further. Moreover, weights may be further amplified with the inclusion of each additional dimension being noted in close proximity. Thus, for example, if a particular document includes mention of a target and a method within 10 words of each other, both the identified target and method may receive a specific weight. If another document includes the method mentioned within 10 words of another method, each term may again receive a weighted value, but the value may be lower since the terms are both within the same dimension. However, if another document includes the target and method mentioned along with an actor, each term may receive a higher weighting. Similarly, if another document included the target and method mentioned within three words of each other, such terms may again be assigned a higher weighting factor.

After parsing a plurality of documents and assigning weights to all terms from the lexicon 84 that were encountered in the sampled data, the weighted terms may be indicated to the interface manager 82. The interface manager 82 may be configured to present a graphic display of information relating to the weighted terms via the user interface 72. In some cases, all terms (or at least terms having weights above a predefined threshold) could be listed with a corresponding value (e.g., summing all of the weighted values for each respective term). The listing could provide the terms in order based on the weighted values. However, in other embodiments, a cloud architecture could be used to present a graphic display of some or all of the terms. For example, a three-dimensional text cloud may be provided by the interface manager 82 with an indication of terms that appeared close to each other with some regularity and with the frequency with which such terms were encountered being indicated.

In an example embodiment, the text cloud may present terms that have a composite value (e.g., based on the sum of all weighted values assigned to each respective term) above a particular threshold. The user may be enabled to adjust the threshold to increase or decrease the number of terms displayed in the text cloud accordingly. Displayed terms may have a size or font that is determined based on the composite value of each term or the frequency of reporting of each respective term. Thus, for example, heavily weighted or frequently appearing terms may appear in large font and lightly weighted or infrequently appearing terms may be displayed in a smaller font. In some embodiments, terms may be organized by color based on their respective dimensions. For example, method terms may have one color, while all actor terms have a different color and each other dimension may be represented by yet another color. Terms may also be placed in the cloud in proximity to other terms with which the respective terms had some association during scoring. Thus, for example, terms that appeared in the same document or within a given threshold of proximity to one another may be displayed in the same cloud. The nearer the relationship during analysis, the closer such terms may appear to each other in the cloud.

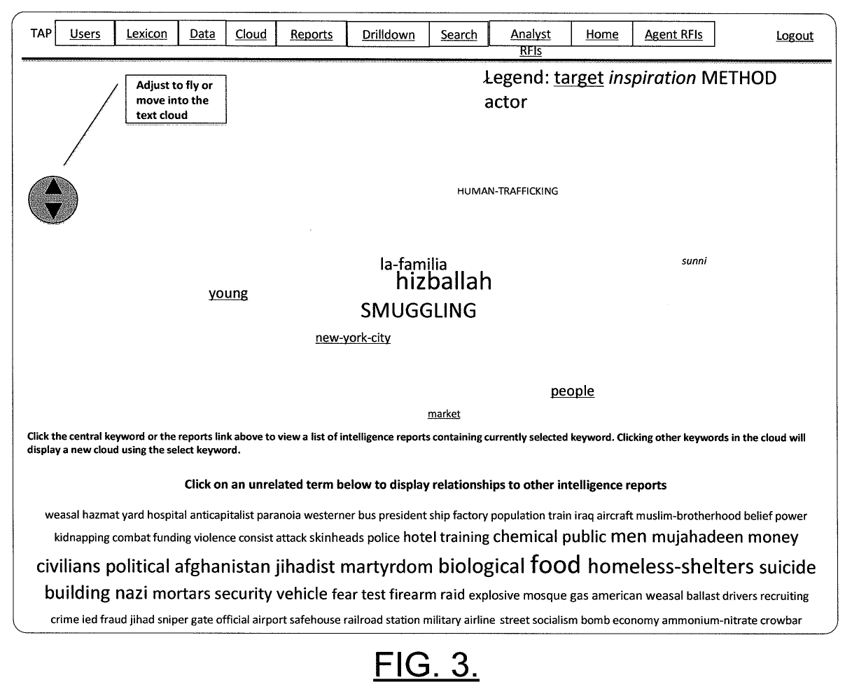

FIG. 3 illustrates an example of a user interface screen according to an example embodiment of the present invention. Although color is used to differentiate between respective dimensions in one embodiment, font style or some other characteristic could alternatively be employed. FIG. 3 uses font style to distinguish between different dimensions for simplicity of demonstration.

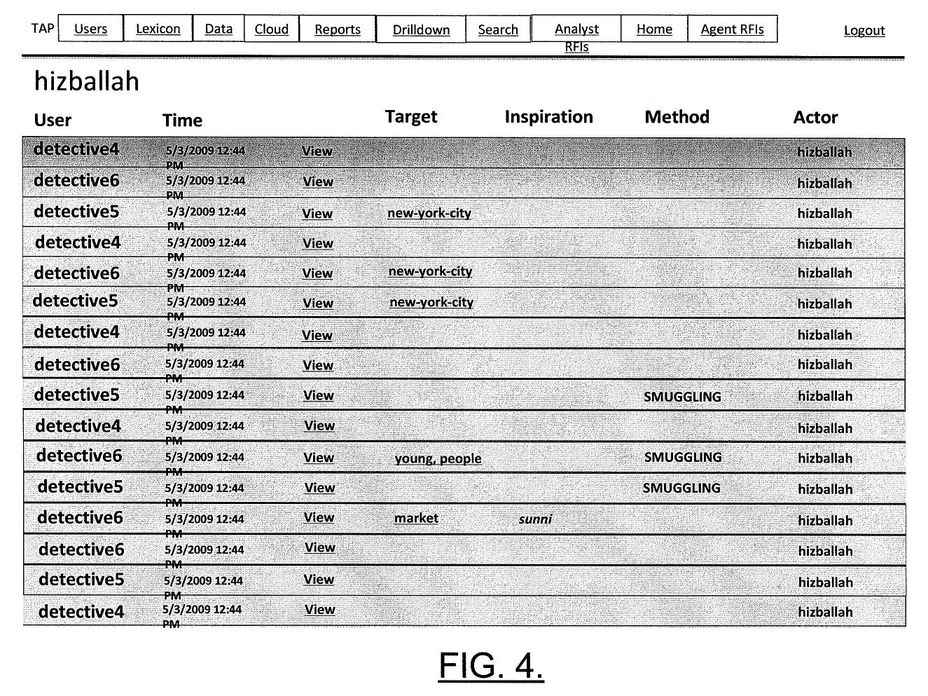

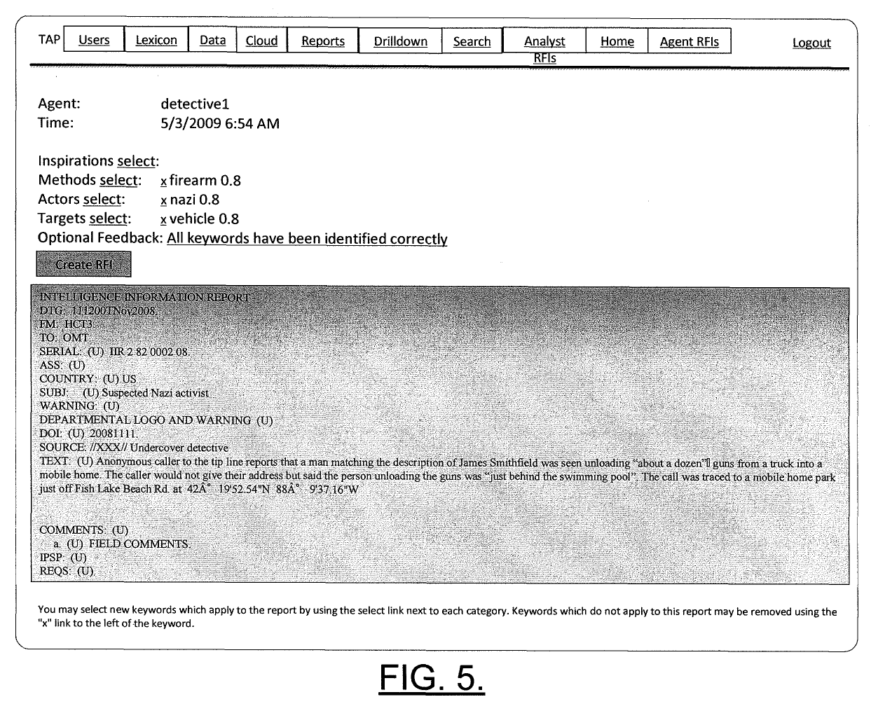

In an example embodiment, a single term may be selected as the cloud focus. The selected term may be displayed in the center of the cloud. All other related terms may then be displayed with reference to the selected term. Terms that are not related to the selected term may be displayed in a list format outside the cloud as shown at the bottom of FIG. 3. However, selection of any term from the list or from another portion of the cloud may reset the cloud display to provide the selected term in the center of the cloud and provide all related terms to the selected term in a new cloud generated based on the selected term. Related terms may also be rotated around the central item (e.g., by clicking and dragging a portion of the cloud to rotate the cloud) to alter the orientation of items in the text cloud. In some embodiments, more detailed information may be retrieved regarding selected terms. In this regard, for example, by selecting an option to view more detailed information regarding a particular term, a display may be provided to show a listing of reports that include the particular term. FIG. 4 illustrates an example of a summary page for detailed information regarding a particular selected term according to an example embodiment of the present invention. In this regard, as shown in FIG. 4, the term “hizballah” has been selected and corresponding reports including the term are shown in a list format. Other terms associated with corresponding other dimensions for each respective report may also be listed. A link is also provided to each respective report as well. FIG. 5 illustrates an example of a report that may provide information for parsing and that may be retrieved using the link.

Accordingly, the threat detector 80 may identify specific terms associated with multi-dimensional threat factors that may be related to terror attacks or other planned anti-social violent attacks. In this regard, the identification of the threat factors may be made based on the incidence of terms identified in the lexicon 84 within data being searched or parsed. The data may be provided via secure or non-secure stored materials or live feeds from various sources. The terms recognized may be weighted based on frequency of incidence and/or based on proximity to other terms or terms of other dimensions. Once identified, the specific terms may then be presented according to flexible and user modifiable criteria by the interface manager 82.

In an example embodiment, the interface manager 82 may be configured to provide one or more different screens, control console or other interface mechanisms via which the user may enter information, experience information or otherwise interface with data presented or to be presented. Although the interface manager 82 may be used to separately provide a display that is unique to example embodiments of the present invention in some cases, in other situations, the interface manager 82 may merely be used to communicate with and provide information to an existing interface of a legacy analytic system. For example, in some cases, the interface manager 82 may be configured to provide information to an existing police or department of defense (DOD) threat analysis interface.

In some examples, a “home” or “cloud” screen may be provided by the interface manager 82, which may be the first screen experienced after a user logs in (e.g., with a username and secure password, via biometrics or some combination of the above). In the home screen, the user may be presented with data regarding the emerging threats in a 3-dimensional text cloud. The four fundamental dimensions of a threat act (e.g., target, inspiration, method and actor) may then be visualized as they are pulled out of the data being parsed. As indicated above, the size of font, spatial relationships between terms, font colors and other characteristics of terms presented may be indicative of specific corresponding threat information. For example, the size of the font of a term may signify frequency of reporting. Also, the spatial relationship between different fundamentals may indicate significance (for example, if the word “Al-Qaeda” as an Actor is close to “car bomb” as a Method in the text cloud, the reporting indicates that Al-Qaeda may be planning to use a car bomb).

In some embodiments, a “user” screen may also be presented to enable a system administrator to create a new user, view all existing users, activate or disable accounts, and/or edit permission levels for all users. The administrator can grant a user access to only the text cloud (e.g., a commander's permission level) or can allow a user to only submit reports and read and respond to Requests for Information (e.g., a field agent's permission level). Other permission levels (e.g., an analyst) that would have the ability to view the text cloud, read reports, manage the database, conduct a Boolean search for reports, edit the lexicon, and send Requests for Information to agents may also be defined.

In an example embodiment, a user may interface with the lexicon 84 (e.g., adding, deleting or modifying lexicon terms) via a “lexicon” screen. The lexicon screen may include an alphabetical listing of all the words that have an association with a multi-dimensional threat factor (or fundamental). A user may be provided with an ability to conduct a Boolean search to find specific terms. Also or alternatively, a user may be enabled to add additional keywords into the lexicon 84 via the lexicon screen. Once a new keyword or term is added, the lexicon 84 has “learned” this term and sifts back through all of the data in order to pull out this term and score it accordingly.

In some embodiments, a “data” screen may be provided to enable users to upload files from the computer's desktop and reset the system by deleting all of the intelligence reports. A separate “reports” screen may also be provided to list all reporting that is relevant to the term that is central in the text cloud. As such, for example, reports from which the threat detector 80 pulled the “central term”. Via this screen, a user may be enabled to conduct traditional database functions (Boolean search, sort ascending/descending by date/agent/scoring, etc.). In some cases there may also be a link provided on the screen next to the report number providing a hyperlink to enable viewing of the actual report.

A “search” screen may also be provided to enable users to enter search terms. Relevant reports may be provided responsive to a hit made based on a particular search. In some cases, a separate screen may also be provided to enable drilldown activity with respect to the most recently-viewed report. The multi-dimensional information associated with a specific report may then be provided on the screen and the user may be enabled to remove a term from the lexicon, if desire, simply by clicking on an “x” or other functional button next to the corresponding term. This may be useful, for example, to indicate that a term was scored incorrectly. The threat detector 80 may then parse back through data at point and adjust accordingly. In some embodiments, still other screens may be provided such as an “analyst RFI” (request for information) screen or an “agent RFI” screen which may indicate completed, pending or unanswered RFIs for a particular agent or analyst.

In some embodiments, locational information may be extracted and plotted on programs that particular units or clients may use (e.g., MGRS, Lat/Long, and street/city/country information Google Earth, ArcView, FalconView, etc.). Extracted information may be provided in an analysis overlay. As such, a user may be enabled to click on a “map” link on the “reports” section and automatically be shown the plot of the location in that program. In some cases, entity resolution may be provided to enable or facilitate distinguishing between similar names. Other traditional database functions may also be provided. For example, clients may be enabled to sort reports (e.g., in ascending/descending order) by date, location, agent, or strength in scoring or frequency. Temporal analysis, geo-parameters and other tools may also be implemented for database manipulation to effect data visualization. For example, an analyst may want to review data for a specific year to see how a selected parameter affects the text cloud.

In some embodiments, users may also be enabled to customize their profiles to arrange data by theme or to specify particular functionality associated with specific data or specific lexicon terms. As such, users may be enabled to customize their own interfaces and lexicons to reflect their particular needs or desires. Some embodiments may also include modulation within the rating scheme. For example, sometimes a source may be unreliable or misleading (either intentionally or unintentionally). As a result, users with administrator rights may be enabled to modulate scoring or ranking for reports from a particular source based on a user defined rating scheme.

An example use case will be described below to illustrate one potential environment in which an embodiment of the present invention may be employed. In this regard, for example, a Special Forces Operational Detachment (SFODA) may be deployed to a specific front line location, where they have established a team house and are charged with training the local police in that area, securing the local population, and gathering atmospherics. The SF team's headquarters, the Battalion or Special Operations Task Force, may have established a Forward Operating Base (FOB) in a building in a large city remotely located relative to the front line location. The Battalion's Headquarters, the Combined Joint Special Operations Task Force or CJSOTF, may have established a headquarters in still another remote location.

Each day, members of the SF team may travel in and around town and conduct meetings with local government, religious, and military leaders at the front line location. At the end of the day, the members may return to their safehouse and draft a report that details their meetings in a Word document on a team laptop. The laptop may be connected to a secure network or intranet that is able to process classified data. The team may then email the Word document to the headquarters. Another team member may log into the system (e.g., the analysis platform 40) using a username and password unique to the team with corresponding permissions set to only allow the member to send reports, view Requests for Information or RFI's, and respond to RFI's. The team member may cut the text from the Word document and paste the text into an input interface and then enter the data into the system (e.g., store the information in a memory location accessible to the analysis platform 40). Teams that are deployed throughout the area may conduct this daily ritual in that all of their individual reports are fed into the SOTF's system. The analysis platform 40 may then process terabytes of information, sifting through the reports, parsing the language, and pulling out the multi-dimensional threat factors or fundamentals.

At headquarters, an intelligence analyst may read reports and analyze the information. The analyst may use a computer to utilize the threat detector 80 and the interface manager 82 to view a 3-D text cloud morph and change as the reports are submitted by different SFODA's. The analyst may also be enabled to move or manipulate the text cloud (e.g., via click and drag operations) to see the different terms and focus in on the ones that are of interest.

A senior manager or commander may also log into the system and be enabled to view the text cloud that shows the emerging threats. The commander may, for example, see different terms emerge (e.g., “FOB Gabe” for a target, “Jihad” for an inspiration, and “car bomb” as a method) in the cloud and therefore be able to appreciate that an actor is the only piece missing. The commander may then send an email to, call or otherwise speak to the analyst to direct efforts to uncover more information about possible actors. The analyst may then send an RFI though the system to the team at the front line location tasking them to gain fidelity. The team can see the RFI when they log into the system and then conducts HUMINT activities in order to attempt to answer the commander's question. The results of their activities may likewise be provided into the analysis platform 40 by typed intelligence reports that may again be parsed for information a new text cloud may be provided to show the name of an actor. Armed with complete information, the commander may be enabled to interdict the enemy much faster and much more effectively. In essence, embodiments of the present invention may therefore significantly reduce the time it would otherwise take to make decisions and analyze information.

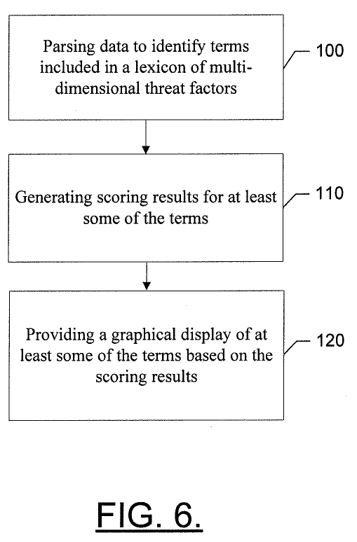

FIG. 6 is a flowchart of a method and program product according to example embodiments of the invention. It will be understood that each block or step of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device and executed by a processor. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture including instruction means which implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 6, may include parsing data to identify terms included in a lexicon of multi-dimensional threat factors at operation 100 and generating (e.g., via a processor) scoring results for at least some of the terms at operation 110. The method may further include providing a graphical display of at least some of the terms based on the scoring results at operation 120.

In some embodiments, certain ones of the operations above may be modified or further amplified as described below. It should be appreciated that each of the modifications or amplifications below may be included with the operations above either alone or in combination with any others among the features described herein. In an example embodiment, the method may further include parsing text data associated with intelligence reports stored in a secure or unsecure location or associated with content accessible via the world wide web. In some embodiments, parsing data may include parsing data to identify terms included in the lexicon defining multi-dimensional threat factors comprising target, inspiration, method and actor. In an example embodiment, generating scoring results may include generating a score for each term based on frequency of occurrence of each respective term or based on the proximity of occurrence of one term of the lexicon to another term of the lexicon. In some cases, providing the graphical display may include generating a text cloud in which terms are displayed based on the scoring results. Within the text cloud each term shown therein may be provided with a corresponding first characteristic indicative of a particular multi-dimensional threat factor with which each term is associated and a corresponding second characteristic indicative of the scoring results for each respective term. In some cases, a selected term may be provided in a center of the text cloud along with related terms to the selected term proximately located within the text cloud. Meanwhile, terms unrelated to the selected term may be provided in a list outside the text cloud.

In an example embodiment, an apparatus for performing the method of FIG. 6 above may comprise a processor (e.g., the processor 70) configured to perform some or each of the operations (100-120) described above. The processor may, for example, be configured to perform the operations (100-120) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-120 may comprise, for example, the processor 70, or respective ones of the threat detector 80 or the interface manager 82, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising a processor configured to at least to perform:
parsing data to identify terms included in a lexicon of multi-dimensional threat factors;
generating scoring results for at least some of the terms; and
providing a graphical display of at least some of the terms based on the scoring results.

2. The apparatus of claim 1, wherein the processor is further configured to perform parsing of text data associated with intelligence reports stored in a secure or unsecure location or associated with content accessible via the world wide web.

3. The apparatus of claim 1, wherein the processor is further configured to parse the data to identify terms included in the lexicon defining multi-dimensional threat factors comprising target, inspiration, method and actor.

4. The apparatus of claim 1, wherein the processor is further configured to generate scoring results by generating a score for each term based on frequency of occurrence of each respective term or based on the proximity of occurrence of one term of the lexicon to another term of the lexicon.

5. The apparatus of claim 1, wherein the processor is further configured to provide the graphical display by generating a text cloud in which terms are displayed based on the scoring results.

6. The apparatus of claim 5, wherein the processor is further configured to provide the graphical display by providing each term with a corresponding first characteristic indicative of a particular multi-dimensional threat factor with which each term is associated and a corresponding second characteristic indicative of the scoring results for each respective term.

7. The apparatus of claim 5, wherein the processor is further configured to provide the graphical display by providing a selected term in a center of the text cloud along with related terms to the selected term proximately located within the text cloud.

8. The apparatus of claim 7, wherein the processor is further configured to provide the graphical display by providing terms unrelated to the selected term in a list outside the text cloud.

9. A method comprising:
parsing data to identify terms included in a lexicon of multi-dimensional threat factors;
generating, via a processor, scoring results for at least some of the terms; and
providing a graphical display of at least some of the terms based on the scoring results.

10. The method of claim 9, wherein parsing data comprises parsing text data associated with intelligence reports stored in a secure or unsecure location or associated with content accessible via the world wide web.

11. The method of claim 9, wherein parsing data comprises parsing data to identify terms included in the lexicon defining multi-dimensional threat factors comprising target, inspiration, method and actor.

12. The method of claim 9, wherein generating scoring results comprises generating a score for each term based on frequency of occurrence of each respective term or based on the proximity of occurrence of one term of the lexicon to another term of the lexicon.

13. The method of claim 9, wherein providing the graphical display comprises generating a text cloud in which terms are displayed based on the scoring results.

14. The method of claim 13, wherein providing the graphical display further comprises providing each term with a corresponding first characteristic indicative of a particular multi-dimensional threat factor with which each term is associated and a corresponding second characteristic indicative of the scoring results for each respective term.

15. The method of claim 13, wherein providing the graphical display further comprises providing a selected term in a center of the text cloud along with related terms to the selected term proximately located within the text cloud.

16. The method of claim 15, wherein providing the graphical display further comprises providing terms unrelated to the selected term in a list outside the text cloud.

17. A computer program product comprising at least one computer-readable storage medium having computer-executable program code instructions stored therein, the computer-executable program code instructions comprising:
program code instructions for parsing data to identify terms included in a lexicon of multi-dimensional threat factors;
program code instructions for generating scoring results for at least some of the terms; and
program code instructions for providing a graphical display of at least some of the terms based on the scoring results.

18. The computer program product of claim 17, wherein program code instructions for parsing data include instructions for parsing text data associated with intelligence reports stored in a secure or unsecure location or associated with content accessible via the world wide web.

19. The computer program product of claim 17, wherein program code instructions for parsing data include instructions for parsing data to identify terms included in the lexicon defining multi-dimensional threat factors comprising target, inspiration, method and actor.

20. The computer program product of claim 17, wherein program code instructions for providing the graphical display include instructions for generating a text cloud in which terms are displayed based on the scoring results.
